(19) United States
(12) Patent Application Publication
(10) Pub. No.: US 2016/0215182 A1
(43) Pub. Date: Jul. 28, 2016

(54) WATER-DISPERSIBLE PRESSURE-SENSITIVE ADHESIVE COMPOSITION, PRESSURE-SENSITIVE ADHESIVE LAYER, PRESSURE-SENSITIVE ADHESIVE OPTICAL FILM, AND IMAGE DISPLAY DEVICE

(71) Applicant: NITTO DENKO CORPORATION, Osaka (JP)

(72) Inventors: Toshitaka Takahashi, Ibaraki-shi (JP); Yousuke Makihata, Ibaraki-shi (JP); Kayo Shimokawa, Ibaraki-shi (JP); Mizuho Nagata, Ibaraki-shi (JP); Kenichi Okada, Ibaraki-shi (JP); Toshitsugu Hosokawa, Ibaraki-shi (JP)

(73) Assignee: NITTO DENKO CORPORATION, Ibaraki-shi, Osaka (JP)

(21) Appl. No.: 14/916,969

(22) PCT Filed: Feb. 7, 2014
(86) PCT No.: PCT/JP2014/067677

§ 371 Date: Mar. 4, 2016

(30) Foreign Application Priority Data
Sep. 6, 2013 (JP) 2013-185471

(51) Int. Cl. C09J 151/00; B32B 7/12

(52) U.S. Cl. CPC C09J 151/003; B32B 7/12; B32B 2264/025; B32B 2457/20; B32B 2255/26

(57) ABSTRACT

It is an object of the invention to provide a water-dispersible pressure-sensitive adhesive composition capable of forming a pressure-sensitive adhesive layer having removability and a sufficient level of adhesion reliability and to provide a pressure-sensitive adhesive layer made from such a water-dispersible pressure-sensitive adhesive composition. It is another object of the invention to provide a pressure-sensitive adhesive optical film including an optical film and such a pressure-sensitive adhesive layer provided on at least one side of the optical film and to provide an image display device having such a pressure-sensitive adhesive optical film. The present invention relates to a water-dispersible pressure-sensitive adhesive composition, comprising emulsion particles each having a core-shell structure in which (A) a (meth)acryl copolymer forms a core layer and (B) another (meth)acryl copolymer forms a shell layer, wherein the (meth)acryl copolymer (B) has a glass transition temperature of −10° C. to 20° C.

### TECHNICAL FIELD

The invention relates to a water-dispersible pressure-sensitive adhesive composition, a pressure-sensitive adhesive layer made from the water-dispersible pressure-sensitive adhesive composition, a pressure-sensitive adhesive optical film including an optical film and the pressure-sensitive adhesive layer provided on at least one side of the optical film. The invention also relates to an image display device, such as a liquid crystal display device, an organic electroluminescent (EL) display device, a cathode ray tube (CRT), a plasma display panel (PDP), produced with the pressure-sensitive adhesive optical film.

### BACKGROUND ART

Image display devices such as liquid crystal display devices (LCD), organic EL display devices, etc. have an image-forming mechanism including polarizing elements as essential components. For example, therefore, in a liquid crystal display device, polarizing elements are essentially placed on both sides of a liquid crystal cell, and generally, polarizing plates are attached as the polarizing elements. Besides polarizing plates, various optical elements have been used in display panels such as liquid crystal panels and organic EL panels for improving display quality. Front face plates are also used to protect image display devices such as liquid crystal display devices, organic EL display devices, CRTs, and PDPs or to provide a high-grade appearance or a differentiated design. Examples of parts used in image display devices such as liquid crystal display devices and organic EL display devices or parts used together with image display devices, such as front face plates, include retardation plates for preventing discoloration, viewing angle-widening films for improving the viewing angle of liquid crystal displays, brightness enhancement films for increasing the contrast of displays, and surface treatment films such as hard-coat films for use in imparting scratch resistance to surfaces, antiglare treatment films for preventing glare on image display devices, and anti-reflection films such as anti-reflective films and low-reflective films. These films are generically called optical films.

When such optical films are bonded to a display panel such as a liquid crystal cell or an organic EL panel or bonded to a front face plate, a pressure-sensitive adhesive is generally used. In the process of bonding an optical film to a display panel such as a liquid crystal cell or an organic EL panel or to a front face plate or bonding optical films together generally reduce optical loss. Therefore, a pressure-sensitive adhesive is used to bond the materials together. In such a case, a pressure-sensitive adhesive optical film including an optical film and a pressure-sensitive adhesive layer previously formed on one side of the optical film is generally used, because it has some advantages such as no need for a drying process to fix the optical film.

In the process of bonding a pressure-sensitive adhesive optical film to a display panel such as a liquid crystal cell or an organic EL panel or to a front face plate, they can be misaligned, or a contaminant can be caught between the bonded surfaces. In such a case, the optical film may be peeled off from the liquid crystal cell or the like and be reused. When peeled off, the pressure-sensitive adhesive optical film is required not to have an adhesive state that can change the gap of the liquid crystal cell, reduce the function of the organic EL panel, or break the optical film. In other words, the pressure-sensitive adhesive optical film is required to have removability (reworkability) so that it can be easily peeled off.

Particularly, in recent years, there is a trend to reduce the thickness of image display devices, and thus there is also a trend to reduce the thickness of the display panels for constituting image display devices and to reduce the thickness of the pressure-sensitive adhesive optical films to be attached to the display panels. There are problems as follows. If a thinner glass plate is used to form a display panel, the glass plate will be more likely to break in the process of peeling off a pressure-sensitive adhesive optical film attached to the glass plate. On the other hand, if a thinner optical film (support) is used to form the pressure-sensitive adhesive optical film, the optical film will be more likely to break in the process of peeling off the pressure-sensitive adhesive optical film. Such breakage becomes more significant as the size of the pressure-sensitive adhesive optical film increases.

In order to prevent such breakage of the display panel or the optical film of the pressure-sensitive adhesive optical film as the adherend, it is preferred to allow the pressure-sensitive adhesive layer of the pressure-sensitive adhesive optical film to have lower peel strength. On the other hand, such a reduction in the peel strength of the pressure-sensitive adhesive layer can lead to a reduction in the practical adhesion and to degradation of the adhesion reliability. Thus, there has been a trade-off between the removability and the adhesion reliability, and there has been a demand for achieving both the removability and the adhesion reliability successfully.

Such successful achievement of both the removability and the adhesion reliability has also been widely demanded of pressure-sensitive adhesives for applications other than optical film applications.

A common known method for increasing the removability includes increasing the elastic modulus of pressure-sensitive adhesives. For example, there is disclosed a removable pressure-sensitive adhesive sheet that is freely attachable to objects (see, for example, Patent Document 1).

### PRIOR ART DOCUMENT

### Patent Document

Patent Document 1: JP-A-08-67860

### SUMMARY OF THE INVENTION

### Problems to be Solved by the Invention

The pressure-sensitive adhesive sheet disclosed in Patent Document 1, which is for use in fastening systems for disposable diapers and the like, is not enough in terms of adhesive reliability. The pressure-sensitive adhesive used to form the pressure-sensitive adhesive tape disclosed in Patent Document 1 contains an elastomer and thus has low transparency, which is not suitable, for example, in the field of high-transparency requiring applications such as optical applications.

In order to improve productivity, it is considered preferable to achieve high-speed peeling in the removal process. In general, however, the peel strength increases as the peel rate increases in the process of peeling off pressure-sensitive adhesive sheets, and there is a problem in that conventional pressure-sensitive adhesive layers are difficult to peel off at high speed.

It is therefore an object of the invention to provide a water-dispersible pressure-sensitive adhesive composition capable of forming a pressure-sensitive adhesive layer having removability and a sufficient level of adhesion reliability and to provide a pressure-sensitive adhesive layer made from such a water-dispersible pressure-sensitive adhesive composition. It is another object of the invention to provide a pressure-sensitive adhesive optical film including an optical film and such a pressure-sensitive adhesive layer provided on at least one side of the optical film and to provide an image display device having such a pressure-sensitive adhesive optical film.

### Means for Solving the Problems

As a result of intensive studies to solve the problems, the inventors have accomplished the invention based on the finding that the problems can be solved by means of the water-dispersible pressure-sensitive adhesive composition described below.

The present invention relates to a water-dispersible pressure-sensitive adhesive composition, comprising emulsion particles each having a core-shell structure in which (A) a (meth)acryl copolymer forms a core layer and (B) another (meth)acryl copolymer forms a shell layer, wherein

the (meth)acryl copolymer (B) has a glass transition temperature of −10° C. to 20° C. The water-dispersible pressure-sensitive adhesive composition of the present invention is useful for optical film applications.

In the water-dispersible pressure-sensitive adhesive composition, the emulsion particles preferably have a glass transition temperature of −25° C. to 15° C.

In the water-dispersible pressure-sensitive adhesive composition, the (meth)acryl copolymer (A) preferably has a glass transition temperature of less than 0° C.

In the water-dispersible pressure-sensitive adhesive composition, the (meth)acryl copolymer (A) preferably has a glass transition temperature lower than the glass transition temperature of the (meth)acryl copolymer (B).

In the water-dispersible pressure-sensitive adhesive composition, the (meth)acryl copolymers (A) and (B) are preferably each obtained by emulsion polymerization of a monomer component comprising an alkyl (meth)acrylate and a carboxyl group-containing monomer, and the monomer component contains 0.1 to 8% by weight of the carboxyl group-containing monomer.

The present invention also relates to a pressure-sensitive adhesive layer made from the water-dispersible pressure-sensitive adhesive composition. The pressure-sensitive adhesive layer of the present invention is useful for optical film applications.

The pressure-sensitive adhesive layer has a first peel strength when bonded to glass and then peeled off from the glass at an angle of 1800 and a peel rate of 0.5 m/minute, 1.5 m/minute, or 2.5 m/minute under a 23° C. atmosphere and also has a second peel strength when bonded to glass and then peeled off from the glass at an angle of 180° and a peel rate of 0.005 m/minute under a 23° C. atmosphere, wherein the first peel strength is preferably equal to or lower than the second peel strength.

The pressure-sensitive adhesive layer preferably has a peel strength of 5 N/25 mm or less when bonded to glass and then peeled off from the glass at an angle of 180° and a peel rate of 0.5 m/minute, 1.5 m/minute, or 2.5 m/minute under a 23° C. atmosphere.

The present invention also relates to a pressure-sensitive adhesive optical film comprising an optical film and the pressure-sensitive adhesive layer provided on at least one side of the optical film, and an image display device comprising the pressure-sensitive adhesive optical film.

### Effect of the Invention

The invention makes it possible to provide a water-dispersible pressure-sensitive adhesive composition capable of forming a pressure-sensitive adhesive layer having removability and a sufficient level of adhesion reliability. The invention also makes it possible to provide a pressure-sensitive adhesive layer made from the water-dispersible pressure-sensitive adhesive composition, a pressure-sensitive adhesive optical film, and an image display device.

### BRIEF DESCRIPTION OF THE DRAWING

FIG. 1 is a graph showing the relationship between the peel rate and the peel strength in Examples 1 and 2 and Comparative Examples 1 to 3.

### MODE FOR CARRYING OUT THE INVENTION

The water-dispersible pressure-sensitive adhesive composition of the invention includes emulsion particles each having a core-shell structure in which (A) a (meth)acryl copolymer forms a core layer and (B) another (meth)acryl copolymer forms a shell layer, wherein the (meth)acryl copolymer (B) has a glass transition temperature (Tg) of −10° C. to 20° C.

The (meth)acryl copolymer (B) that forms the shell layer has a glass transition temperature of −10° C. to 20° C. The glass transition temperature is preferably higher than −10° C., more preferably −5° C. or higher, even more preferably higher than −5° C., further more preferably −3° C. or higher, still more preferably 0° C. or higher, yet more preferably higher than 0° C. The glass transition temperature is preferably lower than 20° C., more preferably 18° C. or lower. In the invention, the glass transition temperature of the (meth)acryl copolymer (B) used to form the shell layer, which is expected to come in direct contact with the adherend, is controlled to fall within the above ranges, so that both removability and a sufficient level of adhesion reliability are achieved successfully.

On the other hand, the glass transition temperature of the (meth)acryl copolymer (A) used to form the core layer is not limited and may be set at any appropriate level. For example, the glass transition temperature of the (meth)acryl copolymer (A) is preferably in the range of −60° C. to 100° C., more preferably in the range of −60° C. to 80° C., even more preferably in the range of −55° C. to less than 0° C. In the invention, the glass transition temperature of the (meth)acryl copolymer (B) used to form the shell layer of the core-shell structure is controlled to be relatively high as mentioned above. Preferably, therefore, the glass transition temperature of the (meth)acryl copolymer (A) used to form the core layer should be appropriately controlled so that the overall function of the pressure-sensitive adhesive can be maintained.

In the core-shell structure, the (meth)acryl copolymers (A) and (B) form the core and shell layers, respectively. For example, the glass transition temperature of the emulsion particles with the core-shell structure is preferably, but not limited to, −25 to 15° C., more preferably −25 to 10° C. The overall function of the pressure-sensitive adhesive can be advantageously maintained when the emulsion particles have a glass transition temperature in these ranges.

The glass transition temperature of the (meth)acryl copolymer (A) is preferably lower than that of the (meth)acryl copolymer (B). The difference ((B)-(A)) between the glass transition temperatures of the (meth)acryl copolymers (A) and (B) is preferably, but not limited to, more than 0° C., more preferably 10° C. or more, even more preferably 40° C. or more, further more preferably 50° C. or more.

The glass transition temperatures of the (meth)acryl copolymers (A) and (B) are theoretical values each calculated from the following FOX equation taking into account the types and contents of the monomer units of each polymer.

FOX equation:

$$\frac{1}{Tg} = \frac{{W}_{1}}{{Tg}_{1}} + \frac{{W}_{2}}{{Tg}_{2}} + … + \frac{{W}_{n}}{{Tg}_{n}} \qquad [ Formula 1 ]$$

(Tg: the glass transition temperature (K) of the polymer; Tg₁, Tg₂, . . . Tgₙ: the glass transition temperatures (K) of the homopolymers of the respective monomers; W₁, W₂, . . . Wₙ: the weight fractions of the respective monomers)

It should be noted that the glass transition temperatures of the (meth)acryl copolymers (A) and (B) are calculated based on the monofunctional monomers. Namely, even when the polymers each contain a polyfunctional monomer as a monomer unit, the polyfunctional monomer is neglected in the calculation of the glass transition temperature, because the polyfunctional monomer is used in a small amount so that its influence on the glass transition temperature of the copolymer is low. It should also be noted that an alkoxysilyl group-containing monomer is recognized as a polyfunctional monomer and therefore neglected in the calculation of the glass transition temperatures. The theoretical glass transition temperatures calculated from the FOX equation well agree with actual glass transition temperatures determined from differential scanning calorimetry (DSC), dynamic viscoelasticity, etc.

The (meth)acryl copolymer (B) used to form the shell layer may have any monomer unit and any composition that satisfy the glass transition temperature requirements. Preferably, the (meth)acryl copolymer (B) is obtained by emulsion polymerization of a monomer component containing an alkyl (meth)acrylate. More preferably, the (meth)acryl copolymer (B) is obtained by emulsion polymerization of a monomer component including an alkyl (meth)acrylate and a carboxyl group-containing monomer. As used herein, the term “alkyl (meth)acrylate” refers to an alkyl acrylate and/or an alkyl methacrylate, and “meth” is used in the same meaning in the description.

The alkyl (meth)acrylate preferably has a water solubility in a certain range in view of its reactivity in emulsion polymerization. In addition, the alkyl (meth)acrylate is preferably a C₁ to C₁₈ alkyl (meth)acrylate, the use of which makes it easy to control the glass transition temperature. Examples of the alkyl (meth)acrylate include methyl acrylate, ethyl acrylate, propyl acrylate, n-butyl acrylate, tert-butyl acrylate, n-hexyl acrylate, cyclohexyl acrylate, 2-ethylhexyl acrylate, n-octyl acrylate, lauryl acrylate, tridecyl acrylate, stearyl acrylate and other alkyl esters of acrylic acid; methyl methacrylate, ethyl methacrylate, propyl methacrylate, n-butyl methacrylate, tert-butyl methacrylate, n-hexyl methacrylate, cyclohexyl methacrylate, 2-ethylhexyl methacrylate, n-octyl methacrylate, lauryl methacrylate, tridecyl methacrylate, stearyl methacrylate, isobornyl methacrylate, and other alkyl esters of methacrylic acid. These may be used alone or in combination of two or more. Among these, n-butyl acrylate, 2-ethylhexyl acrylate, methyl methacrylate, and cyclohexyl methacrylate are preferred.

The content of the alkyl acrylate(s) in all monomer units of (meth)acryl copolymer (B) is preferably 60 to 99.9% by weight, more preferably 70 to 99.9% by weight, even more preferably 80 to 99.9% by weight or less, still more preferably 80 to 95% by weight. The alkyl acrylate used to form the (meth)acryl copolymer (B) preferably makes up 30 to 95% by weight of all monomers used to form the whole of particles.

To improve the tackiness of the pressure-sensitive adhesive and provide stability for the emulsion, the monomer component used to form the (meth)acryl copolymer (B) preferably contains a carboxyl group-containing monomer. The carboxyl group-containing monomer may be monomer having a carboxyl group and a radically-polymerizable unsaturated double bond-containing group such as a (meth)acryloyl group or a vinyl group, examples of which include (meth)acrylic acid, itaconic acid, maleic acid, fumaric acid, crotonic acid, carboxyethyl acrylate, and carboxypentyl acrylate. The content of the carboxyl group-containing monomer in all monomer units of the (meth)acryl polymer (B) is preferably from 0.1 to 8% by weight, more preferably from 0.5 to 7% by weight, and even more preferably from 1 to 5% by weight.

In addition to the alkyl (meth)acrylate and the carboxyl group-containing monomer, the monomer component used to form the (meth)acryl copolymer (B) may contain at least one copolymerizable monomer having an unsaturated double bond-containing polymerizable group such as a (meth)acryloyl group or a vinyl group in order to stabilize water dispersibility, to improve adhesion to a base material such as an optical film for the pressure-sensitive adhesive layer, and to improve initial tackiness to the adherend.

An alkoxysilyl group-containing monomer is mentioned as the copolymerizable monomer. The alkoxysilyl group-containing monomer may be a silane coupling agent-type unsaturated monomer having an alkoxysilyl group and a group having at least one unsaturated double bond, such as a (meth)acryloyl group or a vinyl group. The alkoxysilyl group-containing monomer is preferred in order to allow the (meth)acryl copolymer (B) to have a crosslinked structure and improved adhesion to glass.

Examples of the alkoxysilyl group-containing monomer include an alkoxysilyl group-containing (meth)acrylate monomer and an alkoxysilyl group-containing vinyl monomer.

Examples of the alkoxysilyl group-containing (meth)acrylate monomer include (meth)acryloyloxyalkyl-trialkoxysilanes such as (meth)acryloyloxymethyl-trimethoxysilane, (meth)acryloyloxymethyl-triethoxysilane, 2-(meth)acryloyloxyethyl-trimethoxysilane, 2-(meth)acryloyloxyethyl-triethoxysilane, 3-(meth)acryloyloxypropyl-trimethoxysilane, 3-(meth)acryloyloxypropyl-triethoxysilane, 3-(meth)acryloyloxypropyl-tripropoxysilane, 3-(meth)acryloyloxypropyl-triisopropoxysilane, and 3-(meth)acryloyloxypropyl-tributoxysilane; (meth)acryloyloxyalkyl-alkyldialkoxysilanes such as (meth)acryloyloxymethyl-methyldimethoxysilane, (meth)acryloyloxymethyl-methyldiethoxysilane, 2-(meth)acryloyloxyethyl-methyldimethoxysilane, 2-(meth)acryloyloxyethyl-methyldiethoxysilane, 3-(meth)acryloyloxypropyl-methyldimethoxysilane, 3-(meth)acryloyloxypropyl-methyldiethoxysilane, 3-(meth)acryloyloxypropyl-methyldipropoxysilane, 3-(meth)acryloyloxypropyl-methyldiisopropoxysilane, 3-(meth)acryloyloxypropyl-methyldibutoxysilane, 3-(meth)acryloyloxypropyl-ethyldimethoxysilane, 3-(meth)acryloyloxypropyl-ethyldiethoxysilane, 3-(meth)acryloyloxypropyl-ethyldipropoxysilane, 3-(meth)acryloyloxypropyl-ethyldiisopropoxysilane, 3-(meth)acryloyloxypropyl-ethyldibutoxysilane, 3-(meth)acryloyloxypropyl-propyldimethoxysilane, and 3-(meth)acryloyloxypropyl-propyldiethoxysilane; and (meth)acryloyloxyalkyl-dialkyl(mono)alkoxysilanes corresponding to these monomers.

For example, alkoxysilyl group-containing vinyl monomers include vinyltrialkoxysilanes such as vinyltrimethoxysilane, vinyltriethoxysilane, vinyltripropoxysilane, vinyltriisopropoxysilane, and vinyltributoxysilane, and vinylalkyldialkoxysilanes and vinyldialkylalkoxysilanes corresponding thereto; vinylalkyltrialkoxysilanes such as vinylmethyltrimethoxysilane, vinylmethyltriethoxysilane, β-vinylethyltrimethoxysilane, β-vinylethyltriethoxysilane, γ-vinylpropyltrimethoxysilane, γ-vinylpropyltriethoxysilane, γ-vinylpropyltripropoxysilane, γ-vinylpropyltriisopropoxysilane, and γ-vinylpropyltributoxysilane, and (vinylalkyl)alkyldialkoxysilanes and (vinylalkyl)dialkyl(mono)alkoxysilanes corresponding thereto.

The content of the alkoxysilyl group-containing monomer in all monomer units of the (meth)acryl copolymer (B) is preferably 1% by weight or less, more preferably from 0.001 to 1% by weight, even more preferably from 0.01 to 0.5% by weight, and particularly preferably from 0.03 to 0.1% by weight. If it is less than 0.001% by weight, the effect of using the alkoxysilyl group-containing monomer (providing a crosslinked structure and adhesion to glass) may be insufficiently obtained. If it is more than 1% by weight, the pressure-sensitive adhesive layer may have a too high degree of crosslinkage, so that the pressure-sensitive adhesive layer may crack over time.

The copolymerizable monomer may be a phosphate group-containing monomer. The phosphate group-containing monomer is effective in improving adhesion to glass.

For example, the phosphate group-containing monomer may be a phosphate group-containing monomer represented by formula (1) below.

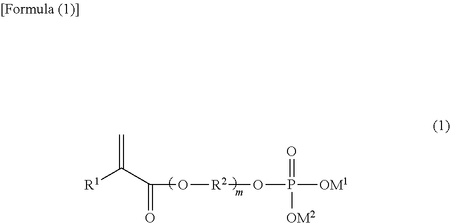

In formula (1), R¹ represents a hydrogen atom or a methyl group, R² represents an alkylene group of 1 to 4 carbon atoms, m represents an integer of 2 or more, and M¹ and M² each independently represent a hydrogen atom or a cation.

In formula (1), m is 2 or more, preferably 4 or more, generally 40 or less, and m represents the degree of polymerization of the oxyalkylene groups (—O—R²—). The polyoxyalkylene group may be a polyoxyethylene group or a polyoxypropylene group, and these polyoxyalkylene groups may include random, block, or graft units. The cation of the salt of the phosphate group is typically, but not limited to, an inorganic cation such as an alkali metal such as sodium or potassium or an alkaline-earth metal such as calcium or magnesium, or an organic cation such as a quaternary amine.

The content of the phosphate group-containing monomer is preferably 20% by weight or less, more preferably from 0.1 to 20% by weight based on the total weight of all monomer units of the (meth)acryl copolymer (B). If it is more than 20% by weight, it is not preferable in view of polymerization stability.

Examples of copolymerizable monomers other than the alkoxysilyl group-containing monomer and the phosphate group-containing monomer include acid anhydride group-containing monomers such as maleic anhydride and itaconic anhydride; aryl (meth)acrylate such as phenyl (meth)acrylate; vinyl esters such as vinyl acetate and vinyl propionate; styrene monomers such as styrene; epoxy group-containing monomers such as glycidyl (meth)acrylate and methylglycidyl (meth)acrylate; hydroxyl group-containing monomers such as 2-hydroxyethyl acrylate and 2-hydroxypropyl acrylate; nitrogen atom-containing monomers such as (meth)acrylamide, N,N-dimethyl(meth)acrylamide, N,N-diethyl(meth)acrylamide, N-isopropyl(meth)acrylamide, N-butyl(meth)acrylamide, N-methylol(meth)acrylamide, N-methylolpropane(meth)acrylamide, (meth)acryloylmorpholine, aminoethyl (meth)acrylate, N,N-dimethylaminoethyl (meth)acrylate, and tert-butylaminoethyl (meth)acrylate; alkoxy group-containing monomers such as methoxyethyl (meth)acrylate and ethoxyethyl (meth)acrylate; cyano group-containing monomers such as acrylonitrile and methacrylonitrile; functional monomers such as 2-methacryloyloxyethyl isocyanate; olefin monomers such as ethylene, propylene, isoprene, butadiene, and isobutylene; vinyl ether monomers such as vinyl ether; halogen atom-containing monomers such as vinyl chloride; and other monomers including vinyl group-containing heterocyclic compounds such as N-vinylpyrrolidone, N-(1-methylvinyl)pyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, and N-vinylmorpholine, and N-vinylcarboxylic acid amides.

Examples of the copolymerizable monomer also include maleimide monomers such as N-cyclohexylmaleimide, N-isopropylmaleimide, N-laurylmaleimide, and N-phenylmaleimide; itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide; succinimide monomers such as N-(meth)acryloyloxymethylenesuccinimide, N-(meth)acryloyl-6-oxyhexamethylenesuccinimide, and N-(meth)acryloyl-8-oxyoctamethylenesuccinimide; and sulfonic acid group-containing monomers such as styrenesulfonic acid, allylsulfonic acid, 2-(meth)acrylamido-2-methylpropanesulfonic acid, (meth)acrylamidopropanesulfonic acid, sulfopropyl (meth)acrylate, and (meth)acryloyloxynaphthalenesulfonic acid.

Examples of the copolymerizable monomer also include glycol acrylate monomers such as polyethylene glycol (meth)acrylate, polypropylene glycol (meth)acrylate, methoxyethylene glycol (meth)acrylate, and methoxypolypropylene glycol (meth)acrylate; and other monomers such as acrylic ester monomers containing a heterocyclic ring or a halogen atom, such as tetrahydrofurfuryl (meth)acrylate and fluoro(meth)acrylate.

A polyfunctional monomer, other than the above alkoxysilyl group-containing monomer, may also be used as the copolymerizable monomer for a purpose such as control of the gel fraction of the water-dispersible pressure-sensitive adhesive composition. The polyfunctional monomer may be a compound having two or more unsaturated double bonds such as those in (meth)acryloyl groups or vinyl groups. Examples that may also be used include (meth)acrylate esters of polyhydric alcohols, such as (mono or poly)alkylene glycol di(meth)acrylates including (mono or poly)ethylene glycol di(meth)acrylates such as ethylene glycol di(meth)acrylate, diethylene glycol di(meth)acrylate, triethylene glycol di(meth)acrylate, trimethylolpropane tri(meth)acrylate, and tetraethylene glycol di(meth)acrylate, (mono or poly)propylene glycol di(meth)acrylate such as propylene glycol di(meth)acrylate, neopentyl glycol di(meth)acrylate, 1,6-hexanediol di(meth)acrylate, pentaerythritol di(meth)acrylate, trimethylolpropane tri(meth)acrylate, pentaerythritol tri(meth)acrylate, and dipentaerythritol hexa(meth)acrylate; polyfunctional vinyl compounds such as divinylbenzene; diacetone acrylamide; and compounds having two or more reactive unsaturated double bonds which have different reactivity respectively, such as allyl (meth)acrylate and vinyl (meth)acrylate. The polyfunctional monomer may also be a compound having a polyester, epoxy or urethane skeleton to which two or more unsaturated double bonds are added in the form of functional groups such as (meth)acryloyl groups or vinyl groups in the same manner as the monomer component, such as polyester (meth)acrylate, epoxy (meth)acrylate, or urethane (meth)acrylate.

When a monofunctional monomer is used as the copolymerizable monomer other than the alkoxysilyl group-containing monomer and the phosphate group-containing monomer, the content of the copolymerizable monomer is preferably 20% by weight or less, more preferably 10% by weight or less, and even more preferably 5% by weight or less based on the total weight of all monomer units of the (meth)acryl copolymer (B) in view of the stability of the aqueous dispersion and prevention of an excessive increase in the viscosity of the aqueous dispersion. When a polyfunctional monomer is used as the copolymerizable monomer, the content of the copolymerizable monomer is preferably 5% by weight or less, more preferably 3% by weight or less, and even more preferably 1% by weight or less based on the total weight of all monomer units of the (meth)acryl copolymer (B) in view of the stability of the aqueous dispersion.

As mentioned above, the (meth)acryl copolymer (A) used to form the core layer is not limited. Preferably, the (meth)acryl copolymer (A) is one obtained by emulsion polymerization of a monomer component containing an alkyl (meth)acrylate. More preferably, the (meth)acryl copolymer (A) is one obtained by emulsion polymerization of a monomer component including an alkyl (meth)acrylate and a carboxyl group-containing monomer.

The alkyl (meth)acrylate used to form the (meth)acryl copolymer (A) preferably has a water solubility in a certain range in view of its reactivity in emulsion polymerization. The C₁ to C₁₈ alkyl (meth)acrylate shown for the (meth)acryl copolymer (B) is preferably used as a main component for the (meth)acryl copolymer (A). Examples of the alkyl (meth)acrylate may be the same as those listed above. In particular, the alkyl (meth)acrylate is preferably a C₃ to C₉ alkyl acrylate, more preferably n-butyl acrylate or 2-ethylhexyl acrylate.

The content of the alkyl (meth)acrylate is preferably 60 to 99.9% by weight, more preferably 70 to 99.9% by weight, even more preferably 80 to 99% by weight, further more preferably 80 to 98% by weight of all monomers used to form the (meth)acryl copolymer (A). The content of the alkyl acrylate used to form the (meth)acryl copolymer (A) is also preferably 3 to 50% by weight, more preferably 3 to 40% by weight based on all monomers used to form the whole of particles.

The monomer component used to form the (meth)acryl copolymer (A) preferably contains a carboxyl group-containing monomer. Examples of the carboxyl group-containing monomer may be the same as those listed for the (meth)acryl copolymer (B). The content of the carboxyl group-containing monomer is preferably 0.1 to 8% by weight, more preferably 0.5 to 7% by weight, even more preferably 1 to 5% by weight based on all monomers used to form the (meth)acryl copolymer (A).

The (meth)acryl copolymer (A) may include a monomer unit derived from the copolymerizable monomer, examples of which are listed above for the (meth)acryl copolymer (B). The copolymerizable monomer may be an alkoxysilyl group-containing monomer, a phosphate group-containing monomer, a polyfunctional monomer, or any other monomer. Any of these copolymerizable monomers may be used at the same content as that for the (meth)acryl copolymer (B).

The (meth)acryl copolymers (A) and (B) each preferably contain a monomer unit derived from the alkyl (meth)acrylate, in which, however, the type of the monomer unit and the composition of the components are not limited and any of the above monomers may be combined as appropriate.

In the invention, the shell layer of the (meth)acryl copolymer (B) prevents the adhesive strength from being high when a reworking process is performed at a high peel rate, in contrast to the prior art, and rather allows the adhesive strength to decrease as the peel rate increases, which makes it possible to achieve a low adhesive strength at a high peel rate so that reworking can be easily performed, while providing high adhesion reliability.

The emulsion particles with the core-shell structure each preferably include the (meth)acryl copolymers (A) and (B) in a solid weight ratio (A)/(B) of 50/95 to 50/50. The ratio is based on 100% by weight of the total of the (meth)acryl copolymers (A) and (B). When the (meth)acryl copolymers (A) and (B) are present in a ratio within this range, the pressure-sensitive adhesive tends to have reliable adhesion and to be prevented from having lower cohesive strength. In other words, the emulsion particle should include 50 to 95% by weight of the (meth)acryl copolymer (B) as the shell layer and 5 to 50% by weight of the (meth)acryl copolymer (A) as the core layer based on 100% by weight of the total of the copolymers (A) and (B). The content of the (meth)acryl copolymer (B) is preferably 60% by weight or more, more preferably 70% by weight or more. On the other hand, the content of the (meth)acryl copolymer (B) is preferably 95% by weight or less, more preferably 90% by weight or less. When the content of the (meth)acryl copolymer (B) is 95% by weight or less, the copolymer (B) can have a good effect without containing any monomer unit other than the monomer units derived from the alkyl (meth)acrylate and the carboxyl group-containing monomer. If the content of the (meth)acryl copolymer (B) is more than 95% by weight, the pressure-sensitive adhesive may have lower cohesive strength and tend to come off over time.

The emulsion particles with the core-shell structure can be obtained by a multi-stage emulsion polymerization process that includes forming the copolymer for the core layer by emulsion polymerization and then forming the copolymer for the shell layer by emulsion polymerization in the presence of the copolymer for the core layer. Specifically, in each emulsion polymerization stage, the monomer component for forming the copolymer for the core or shell layer is polymerized in water in the presence of a surfactant (emulsifier) and a radical polymerization initiator, so that the copolymer for the core or shell layer is formed.

Emulsion polymerization of the monomer component may be performed by a conventional process. In the emulsion polymerization, for example, the monomer component may be appropriately mixed with a surfactant (emulsifying agent), a radical polymerization initiator, and an optional material such as a chain transfer agent. More specifically, each emulsion polymerization stage may be performed, for example, using a known emulsion polymerization method such as a batch mixing method (batch polymerization method), a monomer dropping method, or a monomer emulsion dropping method. In a monomer dropping method, continuous dropping or intermittent dropping is appropriately selected. These methods may be combined as needed. Reaction conditions and other conditions are appropriately selected, in which, for example, the polymerization temperature is preferably from about 40 to about 95° C., and the polymerization time is preferably from about 30 minutes to about 24 hours.

The surfactant (emulsifying agent) for use in the emulsion polymerization may be, but not limited to, any of various surfactants commonly used in emulsion polymerization. As the surfactant, an anionic or a nonionic surfactant is generally used. Examples of the anionic surfactant include higher fatty acid salts such as sodium oleate; alkylarylsulfonate salts such as sodium dodecylbenzenesulfonate; alkylsulfate ester salts such as sodium laurylsulfate and ammonium laurylsulfate; polyoxyethylene alkyl ether sulfate ester salts such as sodium polyoxyethylene lauryl ether sulfate; polyoxyethylene alkyl aryl ether sulfate ester salts such as sodium polyoxyethylene nonyl phenyl ether sulfate; alkyl sulfosuccinic acid ester salts such as sodium monooctyl sulfosuccinate, sodium dioctyl sulfosuccinate, and sodium polyoxyethylene lauryl sulfosuccinate, and derivatives thereof; and polyoxyethylene distyrenatedphenyl ether sulfate ester salts. Examples of the nonionic surfactant include polyoxyethylene alkyl ethers such as polyoxyethylene lauryl ether and polyoxyethylene stearyl ether; polyoxyethylene alkyl phenyl ethers such as polyoxyethylene octyl phenyl ether and polyoxyethylene nonyl phenyl ether; sorbitan higher fatty acid esters such as sorbitan monolaurate, sorbitan monostearate, and sorbitan trioleate; polyoxyethylene sorbitan higher fatty acid esters such as polyoxyethylene sorbitan monolaurate; polyoxyethylene higher fatty acid esters such as polyoxyethylene monolaurate and polyoxyethylene monostearate; glycerin higher fatty acid esters such as oleic acid monoglyceride and stearic acid monoglyceride; and polyoxyethylene-polyoxypropylene block copolymers, and polyoxyethylene distyrenated phenyl ether.

Besides the above non-reactive surfactants, a reactive surfactant having a radical-polymerizable functional group containing an ethylenic unsaturated double bond may be used as the surfactant. The reactive surfactant may be a radical-polymerizable surfactant prepared by introducing a radical-polymerizable functional group (radically reactive group) such as a propenyl group or an allyl ether group into the anionic surfactant or the nonionic surfactant. These surfactants may be appropriately used alone or in any combination. Among these surfactants, the radical-polymerizable surfactant having a radical-polymerizable functional group is preferably used in view of the stability of the aqueous dispersion or the durability of the pressure-sensitive adhesive layer.

Examples of anionic reactive surfactants include alkyl ether surfactants (examples of commercially available products include AQUALON KH-05, KH-10, and KH-20 manufactured by Dai-ichi Kogyo Seiyaku Co., Ltd., ADEKA REASOAP SR-10N and SR-20N manufactured by ADEKA CORPORATION, LATEMUL PD-104 manufactured by Kao Corporation, and others); sulfosuccinic acid ester surfactants (examples of commercially available products include LATEMUL S-120, S-120A, S-180P, and S-180A manufactured by Kao Corporation and ELEMINOL JS-2 manufactured by Sanyo Chemical Industries, Ltd., and others); alkyl phenyl ether surfactants or alkyl phenyl ester surfactants (examples of commercially available products include AQUALON H-2855A, H-3855B, H-3855C, H-3856, HS-05, HS-10, HS-20, HS-30, BC-05, BC-10, and BC-20 manufactured by Dai-ichi Kogyo Seiyaku Co., Ltd., and ADEKA REASOAP SDX-222, SDX-223, SDX-232, SDX-233, SDX-259, SE-10N, and SE-20N manufactured by ADEKA CORPORATION); (meth)acrylate sulfate ester surfactants (examples of commercially available products include ANTOX MS-60 and MS-2N manufactured by Nippon Nyukazai Co., Ltd., ELEMINOL RS-30 manufactured by Sanyo Chemical Industries Co., Ltd., and others); and phosphoric acid ester surfactants (examples of commercially available products include H-3330PL manufactured by Dai-ichi Kogyo Seiyaku Co., Ltd., ADEKA REASOAP PP-70 manufactured by ADEKA CORPORATION, and others). Examples of nonionic reactive surfactants include alkyl ether surfactants (examples of commercially available products include ADEKA REASOAP ER-10, ER-20, ER-30, and ER-40 manufactured by ADEKA CORPORATION, LATEMUL PD-420, PD-430, and PD-450 manufactured by Kao Corporation, and others); alkyl phenyl ether surfactants or alkyl phenyl ester surfactants (examples of commercially available products include AQUALON RN-10, RN-20, RN-30, and RN-50 manufactured by Dai-ichi Kogyo Seiyaku Co., Ltd., ADEKA REASOAP NE-10, NE-20, NE-30, and NE-40 manufactured by ADEKA CORPORATION, and others); and (meth)acrylate sulfate ester surfactants (examples of commercially available products include RMA-564, RMA-568, and RMA-1114 manufactured by Nippon Nyukazai Co., Ltd., and others).

The surfactant is preferably added in an amount of 0.3 to 10 parts by weight, to 100 parts by weight of the monomer component used to form each of the (meth)acryl copolymer (A) and the (meth)acryl copolymer (B). The addition of the surfactant in such an amount can improve adhesive properties and stability such as polymerization stability or mechanical stability.

The radical polymerization initiator may be, but not limited to, any known radical polymerization initiator commonly used in emulsion polymerization. Examples include azo initiators such as 2,2′-azobisisobutylonitrile, 2,2′-azobis(2-methylpropionamidine)disulfate, 2,2′-azobis(2-methylpropionamidine)dihydrochloride, 2,2′-azobis(2-amidinopropane)dihydrochloride, and 2,2′-azobis[2-(2-imidazoline-2-yl)propane]dihydrochloride; persulfate initiators such as potassium persulfate and ammonium persulfate; peroxide initiators such as benzoyl peroxide, tert-butyl hydroperoxide, and hydrogen peroxide; substituted ethane initiators such as phenyl-substituted ethane; and carbonyl initiators such as aromatic carbonyl compounds. These polymerization initiators may be appropriately used alone or in any combination. If desired, the emulsion polymerization may be performed using a redox system initiator, in which a reducing agent is used in combination with the polymerization initiator. This makes it easy to accelerate the emulsion polymerization rate or to perform the emulsion polymerization at low temperature. Examples of such a reducing agent include reducing organic compounds such as ascorbic acid, erythorbic acid, tartaric acid, citric acid, glucose, and metal salts of formaldehyde sulfoxylate or the like; reducing inorganic compounds such as sodium thiosulfate, sodium sulfite, sodium bisulfite, and sodium metabisulfite; and ferrous chloride, Rongalite, and thiourea dioxide.

The content of the radical polymerization initiator is typically from about 0.02 to about 1 part by weight, preferably from 0.02 to 0.5 parts by weight, more preferably from 0.05 to 0.3 parts by weight, based on 100 parts by weight of the monomer components, while it is appropriately selected. If it is less than 0.02 parts by weight, the radical polymerization initiator may be less effective. If it is more than 1 part by weight, the (meth)acryl polymer (A) or the (meth)acryl copolymer (B) in the aqueous dispersion (polymer emulsion) may have a reduced molecular weight, so that the water-dispersible pressure-sensitive adhesive may have reduced durability. In the case of a redox system initiator, the reducing agent is preferably used in an amount of 0.01 to 1 part by weight based on 100 parts by weight of the total amount of the monomer components.

The chain transfer agent is used to control the molecular weight of the water-dispersible-type (meth)acryl polymer. Any chain transfer agent commonly used in emulsion polymerization may be used as needed. Examples include 1-dodecanthiol, mercaptoacetic acid, 2-mercaptoethanol, 2-ethylhexyl thioglycolate, 2,3-dimercapto-1-propanol, mercaptopropionic acid esters, and other mercaptans. These chain transfer agents may be appropriately used alone or in any combination. For example, the content of the chain transfer agent is 0.3 parts by weight or less, preferably from 0.001 to 0.3 parts by weight, based on 100 parts by weight of the monomer components.

The (meth)acryl polymer (A) or the (meth)acryl copolymer (B) preferably has a weight average molecular weight of 1,000,000 or more. In particular, the weight average molecular weight is more preferably from 1,000,000 to 4,000,000. The pressure-sensitive adhesive obtained by the emulsion polymerization is preferred because the polymerization mechanism can produce very high molecular weight. It should be noted, however, that the pressure-sensitive adhesive obtained by the emulsion polymerization generally has a high gel content and cannot be subjected to GPC (gel permeation chromatography) measurement, which means that it is often difficult to identify the molecular weight by actual measurement.

The water-dispersible pressure-sensitive adhesive composition contains, as a main component, the emulsion particles with the core-shell structure. In the process of preparing the emulsion particles with the core-shell structure, an emulsion of the (meth)acryl copolymer (A) and an emulsion of the (meth)acryl copolymer (B), which are not involved in forming the core-shell structure, can be produced. Therefore, the water-dispersible pressure-sensitive adhesive composition may also contain an emulsion of the (meth)acryl copolymer (A) and an emulsion of the (meth)acryl copolymer (B) in addition to the emulsion particles with the core-shell structure.

If necessary, the water-dispersible pressure-sensitive adhesive composition of the invention may contain a crosslinking agent in addition to the emulsion particles with the core-shell structure, emulsion particles of the (meth)acryl copolymer (A), and emulsion particles of the (meth)acryl copolymer (B). The crosslinking agent may be an isocyanate crosslinking agent, an epoxy crosslinking agent, an oxazoline crosslinking agent, an aziridine crosslinking agent, a carbodiimide crosslinking agent, a metal chelate crosslinking agent, or any other crosslinking agent commonly used in the art. When the (meth)acryl copolymer has a functional group, these crosslinking agents can have the effect of reacting with the functional group to form crosslinks.

In general, the content of the crosslinking agent is preferably, but not limited to, about 10 parts by weight or less (on a solids basis) based on 100 parts by weight of the total solids in the water-dispersible pressure-sensitive adhesive composition. It should be noted that the use of the crosslinking agent can tend to reduce the tackiness although the crosslinking agent can impart additional cohesive strength to the pressure-sensitive adhesive layer.

If necessary, the water-dispersible pressure-sensitive adhesive composition of the invention may contain any of various additives such as viscosity modifiers, release modifiers, tackifiers, plasticizers, softeners, glass fibers, glass beads, metal powders, fillers made of other inorganic powders, pigments, colorants (such as pigments and dyes), pH regulators (acids or bases), antioxidants, ultraviolet absorbers, and silane coupling agents without departing from the objects of the invention. The composition may also contain fine particles so that the composition can form a pressure-sensitive adhesive layer having light diffusing properties. Any of these additives may also be added in the form of an emulsion. In this regard, the content of any of these additives is preferably 10 parts by weight or less based on 100 parts by weight of the total solids in the water-dispersible pressure-sensitive adhesive composition.

The emulsion particles in the water-dispersible pressure-sensitive adhesive composition of the invention preferably has a number average particle size of 50 to 150 nm, more preferably 50 to 130 nm, even more preferably 50 to 120 nm.

The pressure-sensitive adhesive layer of the invention is made from the water-dispersible pressure-sensitive adhesive composition described above. The pressure-sensitive adhesive layer can be formed by a process including applying the water-dispersible pressure-sensitive adhesive composition to a support substrate (an optical film or a release film) and then drying the composition.

Various methods may be used in the applying step of the water-dispersible pressure-sensitive adhesive composition. Examples include roll coating, kiss roll coating, gravure coating, reverse coating, roll brush coating, spray coating, dip roll coating, bar coating, knife coating, air knife coating, curtain coating, lip coating, and extrusion coating using a die coater or the like.

In the applying step, the amount of the application should be controlled so that a pressure-sensitive adhesive layer with a predetermined thickness (post-drying thickness) can be formed. The thickness (post-drying thickness) of the pressure-sensitive adhesive layer is generally set within the range of about 1 μm to about 100 μm, preferably within the range of 5 μm to 50 μm, and more preferably within the range of 10 μm to 40 μm.

In the process of forming the pressure-sensitive adhesive layer, the applied water-dispersible pressure-sensitive adhesive composition is then subjected to drying. The drying temperature is preferably 80° C. or more, more preferably 100° C. or more higher than the glass transition temperature (FOX theoretical value) of the water-dispersible pressure-sensitive adhesive composition. The upper limit to the drying temperature is preferably, but not limited to, less than a temperature that is 170° C. higher than the glass transition temperature. When the drying temperature falls within this range, the residual water content of the pressure-sensitive adhesive layer can be reduced, and the rate of the water-induced change in the refractive index of the interfacial part between the particles can also be reduced, so that depolarization can be reduced, which is advantageous. If the drying temperature is less than a temperature that is 80° C. higher than the glass transition temperature, the pressure-sensitive adhesive layer can have a higher water content, so that the water can cause a large difference between the refractive indices of the particles and the interfacial part between the particles and also can cause the ratio of the interfacial part to be high, which can increase light scattering and thus cause depolarization. Such a result is not preferred. The drying time may be from about 0.3 to about 30 minutes, preferably from 0.3 to 10 minutes.

The resulting pressure-sensitive adhesive layer preferably has a water content of 1.0% by weight or less based on the total weight of the pressure-sensitive adhesive layer. The pressure-sensitive adhesive layer preferably has a water content as low as possible, and the content is more preferably 0% by weight. Unfortunately, it is difficult to remove water completely, and the pressure-sensitive adhesive layer usually has a residual water content of about 0.1% by weight.

The pressure-sensitive adhesive layer of the invention preferably has a haze of 2% or less, more preferably 0 to 1% when having a thickness of 25 μm. The pressure-sensitive adhesive layer with a haze of 2% or less can satisfy the level of transparency required for use on optical members. The pressure-sensitive adhesive layer with a haze of more than 2% can be cloudy, which is not preferred for optical applications. The haze may be measured by the method described in the Examples section.

The peel strength of the pressure-sensitive adhesive layer of the invention measured when the pressure-sensitive adhesive layer is bonded to glass and then peeled off at an angle of 180° and a peel rate of 0.5 to 2.5 m/minute (specifically, 0.5 m/minute, 1.5 m/minute, or 2.5 m/minute) under a 23° C. atmosphere is preferably equal to or lower than that measured when the pressure-sensitive adhesive layer is bonded to glass and then peeled off under the same conditions except that the peel rate is 0.005 m/minute. The pressure-sensitive adhesive layer with such a peel strength range can successfully have both a high peel strength at a low peel rate, which means a practical level of adhesion reliability, and a low peel strength for practical removal.

In addition, the peel strength of the pressure-sensitive adhesive layer of the invention measured when the pressure-sensitive adhesive layer is bonded to glass and then peeled off at an angle of 180° and a peel rate of 0.5 to 2.5 m/minute (specifically, 0.5 m/minute, 1.5 m/minute, or 2.5 m/minute) under a 23° C. atmosphere is preferably at most 0.5 times, more preferably 0.05 to 0.4 times that measured when the pressure-sensitive adhesive layer is bonded to glass and then peeled off under the same conditions except that the peel rate is 0.005 m/minute. The pressure-sensitive adhesive layer with such a peel strength range can successfully have both a high peel strength at a low peel rate, which means a practical level of adhesion reliability, and a low peel strength for practical removal.

The peel strength of the pressure-sensitive adhesive layer measured when the pressure-sensitive adhesive layer is bonded to glass and then peeled off at an angle of 180° and a peel rate of 0.5 to 2.5 m/minute (specifically, 0.5 m/minute, 1.5 m/minute, or 2.5 m/minute) under a 23° C. atmosphere is preferably 5 N/25 mm or less, more preferably from 0.1 to 5 N/25 mm. In particular, the peel strength of the pressure-sensitive adhesive layer is preferably from 0.1 to 5 N/25 mm when the pressure-sensitive adhesive layer is peeled off at a peel rate of 0.5 m/minute, and is also preferably from 0.1 to 2 N/25 mm when the pressure-sensitive adhesive layer is peeled off at a peel rate of 1.5 m/minute or 2.5 m/minute.

Examples of the material used to form the release film include a plastic film such as a polyethylene, polypropylene, polyethylene terephthalate, or polyester film, a porous material such as paper, fabric, or nonwoven fabric, and an appropriate thin material such as a net, a foamed sheet, a metal foil, and a laminate thereof. A plastic film is preferably used, because of its good surface smoothness.

Any plastic film capable of protecting the pressure-sensitive adhesive layer may be used, examples of which include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film.

The thickness of the release film is generally from about 5 to about 200 μm, preferably from about 5 to about 100 μm. If necessary, the release film may be subjected to a release treatment and an antifouling treatment with a silicone, fluoride, long-chain alkyl, or fatty acid amide release agent, silica powder or the like, or subjected to an antistatic treatment of coating type, kneading and mixing type, vapor-deposition type, or the like. In particular, when the surface of the release film is appropriately subjected to a release treatment such as a silicone treatment, a long-chain alkyl treatment, or a fluorine treatment, the releasability from the pressure-sensitive adhesive layer can be further increased.

The pressure-sensitive adhesive layer may be exposed. In such a case, the pressure-sensitive adhesive layer may be protected by the release film until it is actually used. The release film may be used as is as a release film for a pressure-sensitive adhesive optical film, so that the process can be simplified.

The water-dispersible pressure-sensitive adhesive composition and the pressure-sensitive adhesive layer of the invention are preferably used for optical film applications as described below. In addition, they can be used for various other applications such as optical protective tapes and transparent double-sided pressure-sensitive adhesive tapes.

The pressure-sensitive adhesive optical film of the invention includes an optical film and the pressure-sensitive adhesive layer or layers placed on one or both sides of the optical film. The pressure-sensitive adhesive optical film of the invention can be formed by the above process, which includes applying the water-dispersible pressure-sensitive adhesive composition to an optical film or a release film and drying the composition. The pressure-sensitive adhesive layer formed on a release film is bonded and transferred onto an optical film.

An optical film may also be coated with an anchor layer or subjected to any adhesion-facilitating treatment such as a corona treatment or a plasma treatment so as to have improved adhesion to a pressure-sensitive adhesive layer, and then the pressure-sensitive adhesive layer may be formed. The surface of the pressure-sensitive adhesive layer may also be subjected to an adhesion-facilitating treatment.

Materials that may be used to form the anchor layer preferably include an anchoring agent selected from polyurethane, polyester, polymers containing an amino group in the molecule, and polymers containing an oxazolinyl group in the molecule, in particular, preferably polymers containing an amino group in the molecule and polymers containing an oxazolinyl group in the molecule. Polymers containing an amino group in the molecule and polymers containing an oxazolinyl group in the molecule allow the amino group in the molecule or an oxazolinyl group in the molecule to react with a carboxyl group or the like in the pressure-sensitive adhesive or to make an interaction such as an ionic interaction, so that good adhesion can be ensured.

Examples of polymers containing an amino group in the molecule include polyethyleneimine, polyallylamine, polyvinylamine, polyvinylpyridine, polyvinylpyrrolidine, and a polymer of an amino group-containing monomer such as dimethylaminoethyl acrylate.

The optical film is, but not limited to the kinds, used for forming image display device such as liquid crystal display. A polarizing plate is exemplified. A polarizing plate including a polarizer and a transparent protective film provided on one side or both sides of the polarizer is generally used.

A polarizer is, but not limited to, various kinds of polarizer may be used. As a polarizer, for example, a film that is uniaxially stretched after having dichromatic substances, such as iodine and dichromatic dye, absorbed to hydrophilic polymer films, such as polyvinyl alcohol-based film, partially formalized polyvinyl alcohol-based film, and ethylene-vinyl acetate copolymer-based partially saponified film; polyene-based alignment films, such as dehydrated polyvinyl alcohol and dehydrochlorinated polyvinyl chloride, etc. may be mentioned. In these, a polyvinyl alcohol-based film on which dichromatic materials such as iodine, is absorbed and aligned after stretched is suitably used. Thickness of polarizer is, but not limited to, generally from about 5 μm to about 80 μm.

A polarizer that is uniaxially stretched after a polyvinyl alcohol-based film dyed with iodine is obtained by stretching a polyvinyl alcohol film by 3 to 7 times the original length, after dipped and dyed in aqueous solution of iodine. If needed the film may also be dipped in aqueous solutions containing boric acid and potassium iodide, which may include zinc sulfate, zinc chloride. Furthermore, before dyeing, the polyvinyl alcohol-based film may be dipped in water and rinsed if needed. By rinsing polyvinyl alcohol-based film with water, effect of preventing un-uniformity, such as unevenness of dyeing, is expected by making polyvinyl alcohol-based film swelled in addition that also soils and blocking inhibitors on the polyvinyl alcohol-based film surface may be washed off. Stretching may be applied after dyed with iodine or may be applied concurrently, or conversely dyeing with iodine may be applied after stretching. Stretching is applicable in aqueous solutions containing boric acid and potassium iodide, and in water bath.

A thermoplastic resin with a high level of transparency, mechanical strength, thermal stability, moisture blocking properties, isotropy, and the like may be used as a material for forming the transparent protective film. Examples of such a thermoplastic resin include cellulose resins such as triacetylcellulose, polyester resins, polyethersulfone resins, polysulfone resins, polycarbonate resins, polyamide resins, polyimide resins, polyolefin resins, (meth)acrylic resins, cyclic olefin polymer resins (norbornene resins), polyarylate resins, polystyrene resins, polyvinyl alcohol resins, and any mixture thereof. The transparent protective film is generally laminated to one side of the polarizer with the adhesive layer, but thermosetting resins or ultraviolet curing resins such as (meth)acrylic, urethane, acrylic urethane, epoxy, or silicone resins may be used to other side of the polarizer for the transparent protective film. The transparent protective film may also contain at least one type of any appropriate additive. Examples of the additive include an ultraviolet absorbing agent, an antioxidant, a lubricant, a plasticizer, a release agent, an anti-discoloration agent, a flame retardant, a nucleating agent, an antistatic agent, a pigment, and a colorant. The content of the thermoplastic resin in the transparent protective film is preferably from 50 to 100% by weight, more preferably from 50 to 99% by weight, still more preferably from 60 to 98% by weight, particularly preferably from 70 to 97% by weight. If the content of the thermoplastic resin in the transparent protective film is 50% by weight or less, high transparency and other properties inherent in the thermoplastic resin can fail to be sufficiently exhibited.

An optical film may be exemplified as other optical layers, such as a reflective plate, a transflective plate, a retardation plate (a half wavelength plate and a quarter wavelength plate included), a viewing angle compensation film, a brightness enhancement film, a surface treatment film or the like, which may be used for formation of a liquid crystal display etc. These are used in practice as an optical film, or as one layer or two layers or more of optical layers laminated with polarizing plate.

The surface treatment film may also be provided on and bonded to a front face plate. Examples of the surface treatment film include a hard-coat film for use in imparting scratch resistance to the surface, an antiglare treatment film for preventing glare on image display devices, and an anti-reflection film such as an anti-reflective film or a low-reflective film, etc. The front face plate is provided on and bonded to the surface of an image display device such as a liquid crystal display device, an organic EL display device, a CRT, or a PDP to protect the image display device or to provide a high-grade appearance or a differentiated design. The front face plate is also used as a support for a λ/4 plate in a 3D-TV. In a liquid crystal display device, for example, the front face plate is provided above a polarizing plate on the viewer side. When the pressure-sensitive adhesive layer according to the present invention is used, the same effect can be produced using a plastic base material such as a polycarbonate or poly(methyl methacrylate) base material for the front face plate, as well as using a glass base material.

Although an optical film with the above described optical layer laminated to the polarizing plate may be formed by a method in which laminating is separately carried out sequentially in manufacturing process of a liquid crystal display device or the like, an optical film in a form of being laminated beforehand has an outstanding advantage that it has excellent stability in quality and assembly workability, and thus manufacturing processes ability of a liquid crystal display device or the like may be raised. Proper adhesion means, such as a pressure-sensitive adhesive layer, may be used for laminating. On the occasion of adhesion of the above described polarizing plate and other optical films, the optical axis may be set as a suitable configuration angle according to the target retardation characteristics or the like.

The pressure-sensitive adhesive optical film of the present invention is preferably used to form various types of image display devices such as liquid crystal display devices. Liquid crystal display devices may be produced according to conventional techniques. Specifically, liquid crystal display devices are generally produced by appropriately assembling a liquid crystal cell or the likes and the pressure-sensitive adhesive optical film and optionally other components such as a lighting system and incorporating a driving circuit according to any conventional technique, except that the pressure-sensitive adhesive optical film of the present invention is used. Any type of liquid crystal cell may also be used such as a TN type, an STN type, a n type, a VA type and an IPS type.

Suitable liquid crystal display devices, such as liquid crystal display device with which the above pressure-sensitive adhesive optical film has been provided on one side or both sides of the display panel such as a liquid crystal cell, and with which a backlight or a reflective plate is used for a lighting system may be manufactured. In this case, the pressure-sensitive adhesive optical film of the present invention may be provided on one side or both sides of the display panel such as a liquid crystal cell. When providing the pressure-sensitive adhesive optical films on both sides, they may be of the same type or of different type. Furthermore, in assembling a liquid crystal display device, suitable parts, such as diffusion plate, anti-glare layer, antireflection film, protective plate, prism array, lens array sheet, optical diffusion plate, and backlight, may be installed in suitable position in one layer or two or more layers.

Subsequently, organic electro luminescence equipment (organic EL display device: OLED) will be explained. Generally, in organic EL display device, a transparent electrode, an organic luminescence layer and a metal electrode are laminated on a transparent substrate in an order configuring an illuminant (organic electro luminescence illuminant). Here, a organic luminescence layer is a laminated material of various organic thin films, and much compositions with various combination are known, for example, a laminated material of hole injection layer including triphenylamine derivatives etc., a luminescence layer including fluorescent organic solids, such as anthracene; a laminated material of electronic injection layer including such a luminescence layer and perylene derivatives, etc.; laminated material of these hole injection layers, luminescence layer, and electronic injection layer etc.

An organic EL display device emits light based on a principle that positive hole and electron are injected into an organic luminescence layer by impressing voltage between a transparent electrode and a metal electrode, the energy produced by recombination of these positive holes and electrons excites fluorescent substance, and subsequently light is emitted when excited fluorescent substance returns to ground state. A mechanism called recombination which takes place in an intermediate process is the same as a mechanism in common diodes, and, as is expected, there is a strong non-linear relationship between electric current and luminescence strength accompanied by rectification nature to applied voltage.

In an organic EL display device, in order to take out luminescence in an organic luminescence layer, at least one electrode must be transparent. The transparent electrode usually formed with transparent electric conductor, such as indium tin oxide (ITO), is used as an anode. On the other hand, in order to make electronic injection easier and to increase luminescence efficiency, it is important that a substance with small work function is used for cathode, and metal electrodes, such as Mg—Ag and Al—Li, are usually used.

In organic EL display device of such a configuration, an organic luminescence layer is formed by a very thin film about 10 nm in thickness. For this reason, light is transmitted nearly completely through organic luminescence layer as through transparent electrode. Consequently, since the light that enters, when light is not emitted, as incident light from a surface of a transparent substrate and is transmitted through a transparent electrode and an organic luminescence layer and then is reflected by a metal electrode, appears in front surface side of the transparent substrate again, a display side of the organic EL display device looks like mirror if viewed from outside.

In an organic EL display device containing an organic electro luminescence illuminant equipped with a transparent electrode on a surface side of an organic luminescence layer that emits light by impression of voltage, and at the same time equipped with a metal electrode on a back side of organic luminescence layer, a retardation plate may be installed between these transparent electrodes and a polarization plate, while preparing the polarization plate on the surface side of the transparent electrode.

Since the retardation plate and the polarization plate have function polarizing the light that has entered as incident light from outside and has been reflected by the metal electrode, they have an effect of making the mirror surface of metal electrode not visible from outside by the polarization action. If a retardation plate is configured with a quarter wavelength plate and the angle between the two polarization directions of the polarization plate and the retardation plate is adjusted to π/4, the mirror surface of the metal electrode may be completely covered.

This means that only linearly polarized light component of the external light that enters as incident light into this organic EL display device is transmitted with the work of polarization plate. This linearly polarized light generally gives an elliptically polarized light by the retardation plate, and especially the retardation plate is a quarter wavelength plate, and moreover when the angle between the two polarization directions of the polarization plate and the retardation plate is adjusted to π/4, it gives a circularly polarized light.

This circularly polarized light is transmitted through the transparent substrate, the transparent electrode and the organic thin film, and is reflected by the metal electrode, and then is transmitted through the organic thin film, the transparent electrode and the transparent substrate again, and is turned into a linearly polarized light again with the retardation plate. And since this linearly polarized light lies at right angles to the polarization direction of the polarization plate, it cannot be transmitted through the polarization plate. As the result, mirror surface of the metal electrode may be completely covered.

### EXAMPLES

Hereinafter, the present invention is more specifically described with reference to the examples, which however are not intended to limit the present invention. In each example, “parts” and “%” are all by weight.

### Example 1

### Preparation of Water-Dispersible Pressure-Sensitive Adhesive Composition

A monomer mixture was obtained by adding 180 parts of butyl acrylate and 10 parts of cyclohexyl methacrylate as raw materials to a vessel and mixing them. Subsequently, a mixture of 10 parts of acrylic acid, 20 parts of AQUALON HS-10 (manufactured by DKS Co. Ltd.) serving as a reactive surfactant, and 780 parts of ion-exchanged water was prepared and then added to the monomer mixture. Using a homomixer (manufactured by Tokushu Kika Kogyo Kabushiki Kaisha), the resulting mixture was stirred at 6,000 rpm for 5 minutes to form a monomer emulsion (A).

Another monomer mixture was obtained by adding 376 parts of butyl acrylate, 344 parts of methyl methacrylate, and 40 parts of cyclohexyl methacrylate as raw materials to another vessel and mixing them. Subsequently, a mixture of 40 parts of acrylic acid, 0.5 parts of 3-methacryloyloxypropyl-trimethoxysilane (KBM-503 manufactured by Shin-Etsu Chemical Co., Ltd.), 8 parts of AQUALON HS-10, and 800 parts of ion-exchanged water was prepared and then added to the monomer mixture. Using a homomixer, the resulting mixture was then stirred at 6,000 rpm for 5 minutes to form a monomer emulsion (B).

Subsequently, the whole amount of the monomer emulsion (A) prepared as described above was added to a reaction vessel equipped with a condenser tube, a nitrogen inlet tube, a thermometer, dropping equipment, and a stirring blade. After the reaction vessel was sufficiently purged with nitrogen under stirring, the reaction liquid was heated to 65° C. After 0.1 parts of ammonium persulfate was added to the reaction vessel, the mixture being kept at 65° C. was subjected to polymerization for 1 hour to form a copolymer for a core layer. Subsequently, after 0.5 parts of ammonium persulfate was added to the reaction vessel, the monomer emulsion (B) was added dropwise to the reaction vessel over 3 hours while the mixture was kept at 65° C. The mixture was then subjected to polymerization for 3 hours to form a shell layer, so that an aqueous dispersion was obtained having a solid concentration of 39% and containing polymer emulsion particles with a core-shell structure. Subsequently, after the aqueous dispersion containing polymer emulsion particles with a core-shell structure was cooled to room temperature, 65 parts of 10% ammonia water was added to the aqueous dispersion to adjust the pH to 7.5, so that a water-dispersible pressure-sensitive adhesive composition was obtained having a solid concentration of 38% and containing emulsion particles with a core-shell structure. The resulting polymer emulsion particles had a number average particle size of 110 nm.

Number average particle size is a value measured by the following method.

<Number Average Particle Size>

The number average particle size of polymer emulsion particles was measured as follows. The prepared water-dispersible pressure-sensitive adhesive composition was diluted with distilled water to a solid content of 0.5% by weight or less, and measured for the number average particle size with the analyzer shown below.

Analyzer: Laser diffraction scattering particle size distribution analyzer (LS13 320 (PIDS mode) manufactured by Beckman Coulter, Inc.)
Refractive index of dispersoid: 1.48 (poly(n-butyl acrylate) was used)
Refractive index of dispersion medium: 1.333

(Formation of Pressure-Sensitive Adhesive Layer)

The water-dispersible pressure-sensitive adhesive composition was applied to a release film (Diafoil MRF-38 (trade name for a polyethylene terephthalate substrate manufactured by Mitsubishi Plastics, Inc.)) with a die coater so that a 25-μm-thick coating would be formed after drying. The coating was then dried at 120° C. for 2 minutes to form a pressure-sensitive adhesive layer. When the peel strength was measured, the pressure-sensitive adhesive layer was transferred for the sake of convenience onto a 38-μm-thick polyethylene terephthalate substrate (PET #38) to form a pressure-sensitive adhesive sheet (pressure-sensitive adhesive layer), in which the substrate had previously undergone an adhesion-facilitating treatment.

(Preparation of Pressure-Sensitive Adhesive Optical Film)

The pressure-sensitive adhesive layer formed on the release film was bonded to the 40-μm-thick acrylic resin protective film of a polarizing plate (including a 60-μm-thick acrylic resin protective film, a 20-μm-thick polarizer, and the 40-μm-thick acrylic resin protective film stacked in this order) to form a pressure-sensitive adhesive optical film.

### Examples 2 to 9 and Comparative Examples 1 to 6

Water-dispersible pressure-sensitive adhesive compositions, pressure-sensitive adhesive sheets (pressure-sensitive adhesive layers), and pressure-sensitive adhesive optical films were prepared as in Example 1, except that the core and shell layers were each formed with the composition shown in Table 1. In Comparative Example 2, PEG500 (polyethylene glycol, 500 in molecular weight) was added to make up 5% by weight of the total solids in the polymer emulsion particles in the resulting water-dispersible pressure-sensitive adhesive composition. In Comparative Example 3, an oxazoline group-containing polymer (EPOCROS WS700 (trade name) manufactured by NIPPON SHOKUBAI CO., LTD.) was added to make up 2% by weight of the total solids in the polymer emulsion particles in the resulting water-dispersible pressure-sensitive adhesive composition.

TABLE 1
Components of water-dispersible pressure-sensitive adhesive composition

| | Core layer | | | | | | | Shell layer | | | | | | Tg | Additive | |
|---|---|---|---|---|---|---|---|---|---|---|---|---|---|---|---|---|
| | | | | | | | Core | | | | | | Shell | (° C.) of | | Added |
| | Composition (wt %) | | | | | Tg | ratio | Composition (wt %) | | | | Tg | ratio | emulsion | | amount |
| | BA | 2EHA | MMA | CHMA | AA | (° C.) | (wt %) | BA | MMA | CHMA | AA | (° C.) | (wt %) | particles | Type | (wt %) |
| Example 1 | 90 | | | 5 | 5 | −36.4 | 20 | 47 | 43 | 5 | 5 | 14.5 | 80 | 2.6 | — | — |
| Example 2 | 90 | | | 5 | 5 | −36.4 | 30 | 45 | 45 | 5 | 5 | 17.4 | 70 | −1.1 | — | — |
| Example 3 | 50 | | 40 | 5 | 5 | 10.2 | 20 | 55 | 35 | 5 | 5 | 3.4 | 80 | 4.8 | — | — |
| Example 4 | | 90 | | 5 | 5 | −46.1 | 20 | 50 | 40 | 5 | 5 | 10.2 | 80 | −3.2 | — | — |
| Example 5 | | 90 | | 5 | 5 | −46.1 | 30 | 50 | 40 | 5 | 5 | 10.2 | 70 | −9.4 | — | — |
| Example 6 | | 90 | | 5 | 5 | −46.1 | 50 | 50 | 40 | 5 | 5 | 10.2 | 50 | −21.1 | — | — |
| Example 7 | | 92 | | 5 | 3 | −48.1 | 20 | 52 | 40 | 5 | 3 | 7.5 | 80 | −5.7 | — | — |
| Example 8 | | 94 | | 5 | 1 | −50.1 | 20 | 54 | 40 | 5 | 1 | 4.7 | 80 | −8.3 | — | — |
| Example 9 | | 91 | | 5 | 4 | −47.1 | 20 | 51 | 40 | 5 | 4 | 8.9 | 80 | −4.5 | — | — |
| Comparative | 11 | | 80 | 5 | 4 | 77.6 | 20 | 91 | | 5 | 4 | −37.4 | 80 | −20.8 | — | — |
| Example 1 | | | | | | | | | | | | | | | | |
| Comparative | 11 | | 80 | 5 | 4 | 77.6 | 20 | 91 | | 5 | 4 | −37.4 | 80 | −20.8 | PEG500 | 5 |
| Example 2 | | | | | | | | | | | | | | | | |
| Comparative | 11 | | 80 | 5 | 4 | 77.6 | 20 | 91 | | 5 | 4 | −37.4 | 80 | −20.8 | WS700 | 2 |
| Example 3 | | | | | | | | | | | | | | | | |
| Comparative | 90 | | | 5 | 5 | −36.4 | 20 | 80 | 10 | 5 | 5 | −26.2 | 80 | −28.4 | — | — |
| Example 4 | | | | | | | | | | | | | | | | |
| Comparative | 90 | | | 5 | 5 | −36.4 | 20 | 40 | 50 | 5 | 5 | 24.9 | 80 | 10.2 | — | — |
| Example 5 | | | | | | | | | | | | | | | | |
| Comparative | | 90 | | 5 | 5 | −46.1 | 20 | 40 | 50 | 5 | 5 | 24.9 | 80 | 7.4 | — | — |
| Example 6 | | | | | | | | | | | | | | | | |

In Table 1, the composition (% by weight) of the core layer indicates the content of each monomer in all monomers used to form the core layer, and the composition (% by weight) of the shell layer indicates the content of each monomer in all monomers used to form the shell layer.

Table 1 above also shows the glass transition temperatures of the (meth)acryl copolymers obtained to form the core and shell layers, respectively, in the examples and the comparative examples. Each glass transition temperature is the theoretical value calculated by the following method.

<Calculation of Glass Transition Temperature>

The glass transition temperatures of the (meth)acryl copolymers constituting the core and shell layers of the emulsion particles in the water-dispersible pressure-sensitive adhesive composition obtained in each example was calculated from the FOX equation below using the glass transition temperature Tg (K) of the homopolymer of each monomer shown below.

BA: Butyl acrylate (homopolymer's Tg: 228.15 K)
AA: Acrylic acid (homopolymer's Tg: 379.15 K)
2EHA: 2-ethylhexyl acrylate (homopolymer's Tg: 218.15 K)
CHMA: Cyclohexyl methacrylate (homopolymer's Tg: 339.15 K)
MMA: Methyl methacrylate (homopolymer's Tg: 378.15 K) FOX equation:

$$\frac{1}{Tg} = \frac{{W}_{1}}{{Tg}_{1}} + \frac{{W}_{2}}{{Tg}_{2}} + … + \frac{{W}_{n}}{{Tg}_{n}} \qquad [ Formula 2 ]$$

wherein, Tg is the glass transition temperature (K) of the polymer, Tg₁, Tg₂, . . . , Tgₙ are each the glass transition temperature (K) of the homopolymer of each monomer, and W₁, W₂, . . . , Wₙ are each the weight fraction of each monomer.

The pressure-sensitive adhesive layers obtained in the examples and the comparative examples were evaluated as described below. Table 2 shows the evaluation results.

<Peel Strength>

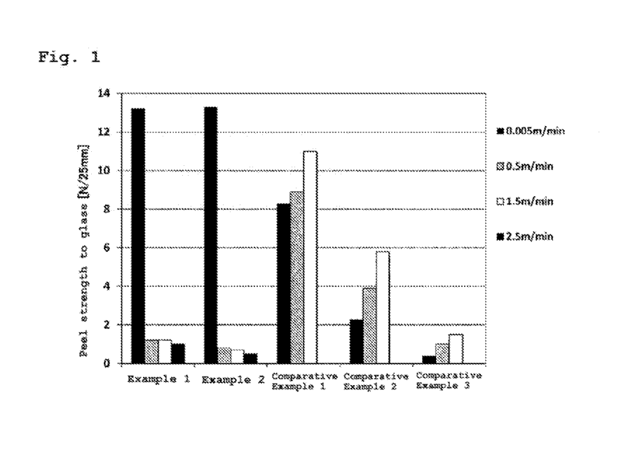

The pressure-sensitive adhesive layer (25 μm) on the release film, obtained in each of the examples and the comparative examples, was bonded to a 38-μm-thick polyethylene terephthalate (PET) substrate, which had previously undergone an adhesion-facilitating treatment, to form a pressure-sensitive adhesive sheet (release film/pressure-sensitive adhesive layer/PET substrate) for use in peel strength measurement. A 25-mm-wide, 180-mm-long piece was cut from the resulting pressure-sensitive adhesive sheet to form a sample for use in peel strength measurement. After the release film was peeled off from the sample, the pressure-sensitive adhesive layer of the sample was pressure-bonded to a non-alkali glass sheet (Corning Eagle XG manufactured by Corning Incorporated) with a 2 kg roller moving back and forth once under the atmosphere at 23° C. and then autoclaved (50° C., 0.5 MPa) for 15 minutes. The resulting laminate was then allowed to stand at 23° C. for 30 minutes. Subsequently, using a peel tester, the sample was peeled off at 23° C., a peel angle of 1800, and a certain peel rate (0.005 m/minute, 0.5 m/minute, 1.5 m/minute, or 2.5 m/minute) when measured for peel strength (N/25 mm). When the peel rate was 1.5 m/minute or more, the peel tester used was a high-speed peel tester (High-Low Temperature Peel Strength Tester manufactured by KOUKEN CO., LTD.). FIG. 1 shows the relationship between the peel rate and the peel strength.

<Haze>

A 50 mm×50 mm piece was cut from the 25-μm-thick pressure-sensitive adhesive layer on the release film, obtained in each of the examples and the comparative examples. The cut piece of the pressure-sensitive adhesive layer was peeled off from the release film and then measured for haze (%) under the atmosphere at 23° C. according to JIS K-7136 using Haze Meter HM-150 manufactured by Murakami Color Research Laboratory.

<Durability Against Humidity>

A 15-inch sized piece was cut from the pressure-sensitive adhesive optical film with the pressure-sensitive adhesive layer obtained in each of the examples and the comparative examples. The cut piece was bonded to a 0.7-mm-thick non-alkali glass sheet (Eagle XG). The resulting laminate was then allowed to stand in an autoclave at 50° C. and 0.5 MPa for 15 minutes. Subsequently, the laminate was stored in an environment at 60° C. and 90% RH for 500 hours and then taken out to room temperature conditions (23° C. and 55% RH), immediately after which the degree of delamination between the stored pressure-sensitive adhesive optical film and the non-alkali glass sheet was observed visually and evaluated according to the criteria below.

5: No delamination occurs.
4: Delamination occurs over a length of at most 0.5 mm from the end of the pressure-sensitive adhesive optical film.
3: Delamination occurs over a length of at most 1.0 mm from the end of the pressure-sensitive adhesive optical film.
2: Delamination occurs over a length of at most 3.0 mm from the end of the pressure-sensitive adhesive optical film.
1: Delamination occurs over a length of more than 3.0 mm from the end of the pressure-sensitive adhesive optical film.

TABLE 2

| | Peel strength (N/25 mm) | | | | Durability | |
|---|---|---|---|---|---|---|
| | 0.005 m/ | 0.5 m/ | 1.5 m/ | 2.5 m/ | against | Haze |
| | minute | minute | minute | minute | humidity | (%) |
| Example 1 | 13.2 | 1.2 | 1.2 | 1.0 | 5 | 0.4 |
| Example 2 | 13.3 | 0.8 | 0.7 | 0.5 | 5 | 0.5 |
| Example 3 | 11.0 | 4.6 | 1.7 | 1.4 | 5 | 0.5 |
| Example 4 | 13.9 | 0.7 | 0.8 | 0.5 | 5 | 0.5 |
| Example 5 | 13.0 | 0.7 | 0.6 | 0.6 | 5 | 0.6 |
| Example 6 | 10.3 | 3.7 | 1.3 | 1.1 | 5 | 0.7 |
| Example 7 | 9.0 | 1.3 | 0.5 | 0.3 | 5 | 0.4 |
| Example 6 | 4.0 | 0.8 | 0.5 | 0.4 | 3 | 0.4 |
| Example 9 | 11.5 | 0.6 | 0.3 | 0.2 | 5 | 0.4 |
| Comparative | 8.3 | 8.9 | 11.0 | — | 5 | 0.4 |
| Example 1 | | | | | | |
| Comparative | 2.3 | 3.9 | 5.8 | — | 2 | 0.5 |
| Example 2 | | | | | | |
| Comparative | 0.4 | 1.0 | 1.5 | — | 1 | 0.4 |
| Example 3 | | | | | | |
| Comparative | 12.6 | 12.1 | 14.6 | 16.0 | 5 | 0.4 |
| Example 4 | | | | | | |
| Comparative | Not adhering | | | | — | — |
| Example 5 | | | | | | |
| Comparative | Not adhering | | | | — | — |
| Example 6 | | | | | | |

1. A water-dispersible pressure-sensitive adhesive composition, comprising emulsion particles each having a core-shell structure in which (A) a (meth)acryl copolymer forms a core layer and (B) another (meth)acryl copolymer forms a shell layer, wherein
the (meth)acryl copolymer (B) has a glass transition temperature of −10° C. to 20° C.

2. The water-dispersible pressure-sensitive adhesive composition according to claim 1, wherein the emulsion particles have a glass transition temperature of −25° C. to 15° C.

3. The water-dispersible pressure-sensitive adhesive composition according to claim 1, wherein the (meth)acryl copolymer (A) has a glass transition temperature of less than 0° C.

4. The water-dispersible pressure-sensitive adhesive composition according to claim 1, wherein the (meth)acryl copolymer (A) has a glass transition temperature lower than the glass transition temperature of the (meth)acryl copolymer (B).

5. The water-dispersible pressure-sensitive adhesive composition according to claim 1, wherein the (meth)acryl copolymers (A) and (B) are each obtained by emulsion polymerization of a monomer component comprising an alkyl (meth)acrylate and a carboxyl group-containing monomer, and the monomer component contains 0.1 to 8% by weight of the carboxyl group-containing monomer.

6. A pressure-sensitive adhesive layer made from the water-dispersible pressure-sensitive adhesive composition according to claim 1.

7. The pressure-sensitive adhesive layer according to claim 6, which has a first peel strength when bonded to glass and then peeled off from the glass at an angle of 180° and a peel rate of 0.5 m/minute, 1.5 m/minute, or 2.5 m/minute under a 23° C. atmosphere and also has a second peel strength when bonded to glass and then peeled off from the glass at an angle of 180° and a peel rate of 0.005 m/minute under a 23° C. atmosphere, wherein the first peel strength is equal to or lower than the second peel strength.

8. The pressure-sensitive adhesive layer according to claim 6, which has a peel strength of 5 N/25 mm or less when bonded to glass and then peeled off from the glass at an angle of 180° and a peel rate of 0.5 m/minute, 1.5 m/minute, or 2.5 m/minute under a 23° C. atmosphere.

9. A pressure-sensitive adhesive optical film comprising an optical film and the pressure-sensitive adhesive layer according to claim 6 provided on at least one side of the optical film.

10. An image display device comprising the pressure-sensitive adhesive optical film according to claim 9.
